(19) United States
(12) Patent Application Publication
(10) Pub. No.: US 2006/0049743 A1
(43) Pub. Date: Mar. 9, 2006

(54) Flat panel display

(76) Inventors: Makoto Okai, Tokorozawa (JP); Takahiko Muneyoshi, Musashimurayama (JP); Tomio Yaguchi, Sagamihara (JP); Nobuaki Hayashi, Kunitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/207,941

(22) Filed: Aug. 22, 2005

(30) Foreign Application Priority Data
Aug. 23, 2004 (JP) 2004-242493

(51) Int. Cl. H01J 63/04; H01J 1/62

(52) U.S. Cl. 313/496

(57) ABSTRACT

A flat panel display having electron sources capable is of emitting electrons uniformly within the display surface. The flat panel display includes a rear panel formed by a rear substrate. Cathode electrodes are formed on the inner surface of the rear substrate. Layers forming the electron sources consist of carbon nanotubes and are formed on the cathode electrodes. The surfaces of layers of the electron sources are bristled with the carbon nanotubes. Multi-walled and single-walled carbon nanotubes are dispersed in the layers of the electron sources.

### FIELD OF THE INVENTION

The present invention relates to a display device to produce a display be emission of electrons into a vacuum; and, more particularly, the present invention relates to a self-luminous flat panel display device having a rear panel and a front panel. The rear panel has cathode electrodes equipped with electron sources formed by nanotubes. The rear panel also has gate electrodes for controlling the amount of electrons released from the electron sources. The front panel has plural layers of different fluorescent colors and anode electrodes. The fluorescent layers are excited to emit light produced by electrons extracted from the rear panel.

### BACKGROUND OF THE INVENTION

Color cathode-ray tubes, in the past, have been widely used as display devices having high brightness and high resolution. However, as information processors and TV broadcasts have improved in image quality in recent years, there is an increasing demand for flat panel displays having the advantages of being lightweight and having a small footprint, as well as high brightness and high resolution characteristics.

Liquid crystal displays (LCDs) and plasma displays represent practical examples of display devices that have been put into practical use as their typical examples. Also, various flat panel displays capable of achieving high brightness, such as electron emission displays and organic EL displays, are approaching commercialization. The electron emission display devices make use of emission of electrons from electron sources into a vacuum. The organic EL display devices are characterized by low power consumption. Plasma displays, electron emission displays, and organic EL displays, requiring no auxiliary lighting light source, are referred to as self-luminous flat panel displays.

It is known that these flat panel displays assume various forms. For example, an electron emission display of the above-described type, as invented by C. A. Spindt and others, has a conic structure for emission of electrons. Another flat panel display has a metal-insulator-metal (MIM) structure for emission of electrons. A further flat panel display has a structure making use of electron emission utilizing a quantum tunneling effect to emit electrons (also known as a surface conduction type electron source). A yet other flat panel display makes use of an electron emission phenomenon exhibited by nanotubes typified by a diamond film, graphite film, and carbon nanotubes.

An electron emission display, representing one example of a self-luminous flat panel display has a rear panel and a front panel. Electron emission type electron sources and gate electrodes that serve as control electrodes are formed on the inner surface of the rear panel. Plural colors of fluorescent layers and anode electrodes (anodes) are formed on the inner surface of the front panel that is opposite to the rear panel. The electron emission display is fabricated by inserting sealing frames into the inner fringes of the front and rear panels, sealing the inner space formed by the panels and frames, and evacuating the inner space. The rear panel has a rear substrate preferably made of glass or alumina. Plural cathode interconnects having electron sources extending in a first direction and juxtaposed in a second direction intersecting the first direction and gate electrodes extending in the second direction and juxtaposed in the first direction are formed on the rear substrate. The amount of electrons emitted from the electron sources and emission of the electrons are controlled by the potential difference between the cathode interconnects and the gate electrodes.

The front panel has a front substrate made of a light-transmissive material, such as glass. The fluorescent layer and anode electrodes are formed on the front substrate. The sealing frames are firmly bonded to the inner fringes of the front and rear panels with an adhesive material, such as frit glass. The degree of vacuum in the inner space formed by the rear panel, front panel, and the sealing frames is 10⁻⁵ to 10⁻⁷ torr, for example. Where the size of the display surface is large, spacers are inserted and held between the rear and front panels to hold the spacing between the substrates at a given value.

Numerous reports, such as the below-listed Non-Patent Reference 1, have been made art regarding a self-luminous flat panel display using electron sources made of carbon nanotubes that are typical examples of nanotubes.

[Non-Patent Reference 1] Eurodisplay 2002, Digest pp. 229-231 (paper 12-4)

It is important for a self-luminous flat panel display having electron sources made of nanotubes, such as carbon nanotubes, to realize a uniform emissive pattern on the display surface. For this purpose, it is necessary to use nanotubes of uniform diameter in the electron sources. Multi-walled carbon nanotubes have been used heretofore as electron sources. The distribution of the diameters is a normal distribution. The ratio of carbon nanotubes which have a minimum diameter and thus play an important role for emission of electrons is small. Consequently, the emission site density is as low as 1000/cm². As a result, it has been difficult to achieve a uniform emission pattern.

Furthermore, where single-walled nanotubes are used, the minimum diameter is stipulated at 0.7 nm by the isolated pentagon rule. Therefore, the ratio of carbon nanotubes having the minimum diameter is high. This should be advantageous for uniform emission of light. In practice, however, the best use of the advantage of the material has not been made because the single-walled carbon nanotubes form bundles due to the van der Waals attraction.

### SUMMARY OF THE INVENTION

It is an object of the present invention to provide a self-luminous flat panel display using carbon nanotubes as electron sources, the nanotubes showing a uniform emission pattern within a display surface.

A self-luminous flat panel display according to the present invention has electron sources made either of a material in which two or more layers of multi-walled and single-walled carbon nanotubes coexist, or of a material in which three or more layers of multi-walled and double-walled carbon nanotubes coexist.

This prevents bundling of single-walled carbon nanotubes or a bundling of double-walled carbon nanotubes. As a result, single-walled carbon nanotubes or double-walled carbon nanotubes, which are uniform in diameter, are selectively made to emit light. Hence, a uniform emission pattern can be accomplished within the display surface.

That is, the self-luminous flat panel display of the present invention is fabricated by bonding together rear and front panels airtightly. A multiplicity of cathode electrodes, that extend in a first direction and are juxtaposed in a second direction intersecting the first direction, are formed on the inner surface of a rear substrate constituting the rear panel. The cathode electrodes have electron sources on their surfaces. A multiplicity of gate electrodes, that extend in the second direction and are juxtaposed in the first direction, are also formed on the inner surface of the rear substrate. A potential is applied to the gate electrodes to control the amount of electrons emitted from the electron sources at the intersections of the cathode and gate electrodes. A multiplicity of pixels at the intersections of the cathode and gate electrodes form a display region.

Plural colors of fluorescent layers and anode electrodes are formed on the inner surface of a transparent front substrate constituting the front panel. The fluorescent layers are excited to emit light by electrons extracted from the electron sources located in the display region of the rear panel. The electron sources consist of nanotubes, which are made of two or more layers of multi-walled and single-walled carbon nanotubes.

In another aspect of the present invention, the nanotubes are made of three or more layers of multi-walled and double-walled carbon nanotubes.

The present invention enables single-walled or double-walled carbon nanotubes, which are uniform in diameter, selectively contribute to emission of light, and so, a self-luminous flat panel display achieving a uniform emission pattern within a display surface is obtained. The term “selectively contributing to emission of light” means that the electric field is concentrated by the thin carbon nanotubes so that electron emission occurs easily.

### BRIEF DESCRIPTION OF THE DRAWINGS

FIG. 1A is a graph illustrating the distribution of the diameters of general nanotubes;

FIG. 1B is a graph illustrating the distribution of the diameters of nanotubes used in accordance with the present invention;

FIG. 2 is a diagrammatic representation of carbon nanotube electron sources in a rear panel fabricated using a carbon nanotube material according to the present invention;

FIG. 3 is a graph in which the emission characteristics of the carbon nanotube electron source layer shown in FIG. 2 are compared with the characteristics of prior art carbon nanotube electron sources;

FIG. 4 is an expanded perspective view of a self-luminous flat panel display representing embodiment 1 of the present invention, as viewed obliquely from above;

FIG. 5 is an expanded perspective view of the self-luminous flat panel display representing embodiment 1, as viewed obliquely from below;

FIG. 6A is a plan view diagrammatically illustrating an example of the configuration of the rear panel in embodiment 1, and FIG. 6B is a close-up plan view of area A in FIG. 6A;

FIG. 7A is a plan view diagrammatically illustrating an example of the configuration of a front panel constituting a self-luminous flat panel display of embodiment 1, and FIG. 7B is a close-up plan view of the area B in FIG. 7A;

FIG. 8A is a perspective view showing an example of the configuration of the rear panel of a self-luminous flat panel display of the present invention, illustrating one step of a process for fabricating the flat panel display;

FIG. 8B is a perspective view illustrating a process step performed subsequent to the step illustrated in FIG. 8A;

FIG. 8C is a perspective view illustrating a process step performed subsequent to the step illustrated in FIG. 8B;

FIG. 8D is a perspective view illustrating a process step performed subsequent to the step illustrated in FIG. 8C;

FIG. 9A is a perspective view showing another example of configuration of the rear panel of the self-luminous flat panel display of the present invention, illustrating a step of a process for fabricating the flat panel display;

FIG. 9B is a perspective view illustrating a process step performed subsequent to the step illustrated in FIG. 9A;

FIG. 9C is a perspective view illustrating a process step performed subsequent to the step illustrated in FIG. 9B;

FIG. 9D is a perspective view illustrating a process step performed subsequent to the step illustrated in FIG. 9C;

FIG. 10 is a partially cutaway perspective view showing one example of the whole structure of the self-luminous flat panel display according to the invention; and

FIG. 11 is a cross-sectional view taken along line I-I of FIG. 10.

### DESCRIPTION OF THE PREFERRED EMBODIMENTS

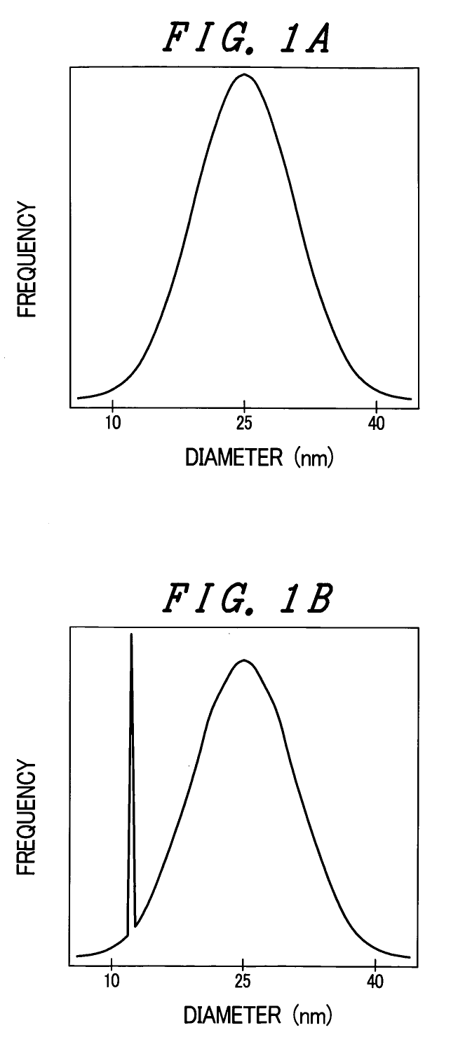

Embodiments of the present invention will be described hereinafter in detail with reference to the drawings. The principles of the present invention will be first described with reference to FIGS. 1A and 1B.

FIG. 1A is a graph illustrating the distribution of the diameters of general nanotubes. In the example of FIG. 1A, the nanotubes are multi-walled carbon nanotubes. In FIG. 1A, the diameter (nm) is plotted on the horizontal axis, while the frequency (relative value) at which a nanotube exists is plotted on the vertical axis. Generally, multi-walled carbon nanotubes are not uniform in the number of layers and so their diameters are widely different from each other. For example, in the case of an average diameter of 20 nm, there exists a diameter variation from 10 nm to about 40 nm.

Where carbon nanotubes are used as electron sources, it is considered that only carbon nanotubes having diameters close to the minimum diameter will contribute to the emission of electrons, because the degree of concentration of an electric field in a carbon nanotube increases in inverse proportion to its diameter. That is, where carbon nanotubes of smaller diameters and carbon nanotubes of larger diameters coexist, the carbon nanotubes of smaller diameters provide a higher degree of concentration of electric field. Therefore, the carbon nanotubes of the smaller diameters selectively emit electrons within the electron sources.

In the case of multi-walled carbon nanotubes having a diameter distribution as shown in FIG. 1A, the ratio of the carbon nanotubes having diameters close to the minimum diameter is very small, and so the emission site density is very low. As a result, it is very difficult to obtain a uniform emission pattern.

It is considered, on the other hand, that single-walled carbon nanotubes are very low in diameter variation. Furthermore, the minimum diameter is stipulated at 0.7 nm by the isolated pentagon rule. Therefore, the ratio of carbon nanotubes having the minimum diameter is large. Consequently, these nanotubes should be advantageous for uniform emission of light. In practice, however, it is impossible to make the best use of the advantages of the material because single-walled carbon nanotubes form bundles by the van der Waals attraction.

FIG. 1B is a graph illustrating the distribution of diameters of nanotubes used in the present invention. In FIG. 1B, carbon nanotubes are shown as an example. In accordance with the invention, a material in which two or more layers of multi-walled and single-walled carbon nanotubes coexist, or a material in which three or more layers of multi-walled and double-walled carbon nanotubes coexist, is used as an electron source.

As shown in FIG. 1B, the diameter distribution of nanotubes used in accordance with the present invention is the sum of the diameter distributions of two or more layers of multi-walled and single-walled carbon nanotubes or the sum of the diameter distributions of three or more layers of multi-walled and double-walled carbon nanotubes. In FIG. 1B, the sharp peak indicates the diameter distribution of single- or double-walled carbon nanotubes.

Typical numerical values are as follows: The average diameter of multi-walled carbon nanotubes is 20 nm, and the half-value width of the diameter distribution is 7 nm. The average diameter of single-walled carbon nanotubes is 1 nm, and the half-value width of the diameter distribution is 0.1 nm. The average diameter of double-walled carbon nanotubes is 2 nm, and the half-value width of the diameter distribution is 0.2 nm. These diameter distributions can be found from transmission electron microscope images of carbon nanotubes.

Where single-walled and multi-walled nanotubes coexist in this way, the van der Waals attraction between single-walled and multi-walled nanotubes is stronger than the van der Waals attraction among single-walled nanotubes or among multi-walled nanotubes. Therefore, there is the advantage that bundling of single-walled nanotubes is prevented. Furthermore, higher mechanical strength is obtained than in the case of only single-walled nanotubes. Also, thermal stability is improved.

To suppress brightness variation in a case where single-walled carbon nanotubes are used to less than 10% of the average brightness, it is is necessary that the half-value width of the diameter distribution be less than 10% of the average diameter, for the following reason. As the diameter is increased, the degree of concentration of the electric field deteriorates, leading to a decrease in the brightness.

To make the emission site density higher than 100 million/cm², it is necessary that existing single-walled carbon nanotubes be more than 1% of all carbon nanotubes. This requirement is also necessary in a material where three or more layers of multi-walled and double-walled carbon nanotubes coexist.

As described so far, according to the present invention, the ratio of single-walled nanotubes or double-walled nanotubes existing alone without being bundled is increased drastically. The emission site density increases. Therefore, uniform emission of light within a display surface can be accomplished.

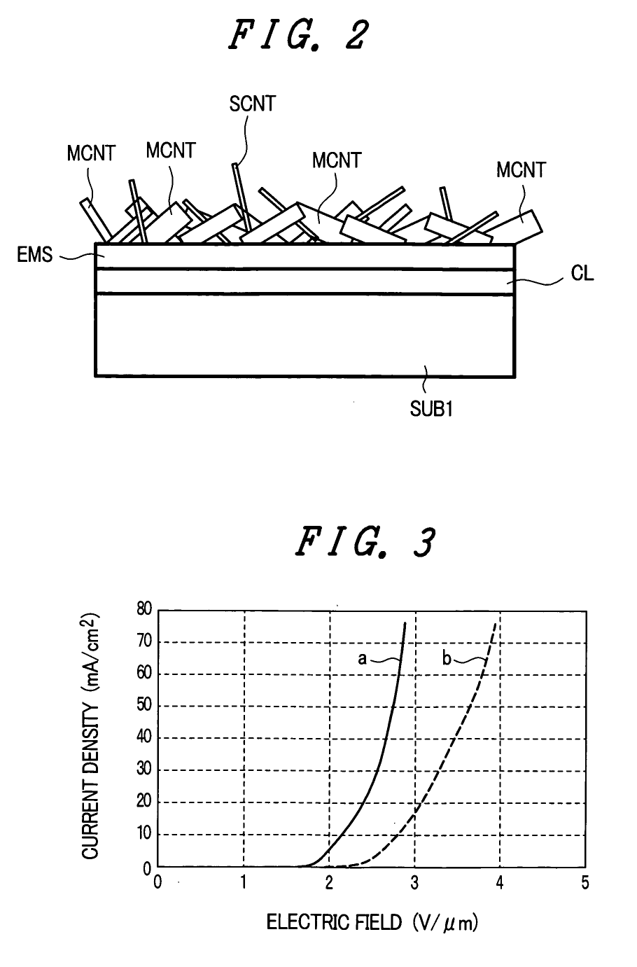

FIG. 2 is a view showing a diagrammatic example of carbon nanotube electron sources in a rear panel fabricated using a carbon nanotube material according to the present invention. In FIG. 2, the rear panel is formed by a rear substrate SUB1. Cathode electrodes CL are formed on the inner surface of the rear substrate SUB1. Carbon nanotube electron source layers EMS are formed on the cathode electrodes. Bristled carbon nanotubes are present on the surfaces of the carbon nanotube electron source layers EMS. In the carbon nanotubes, single-walled carbon nanotubes SCNT are uniformly distributed among multi-walled carbon nanotubes MCNT.

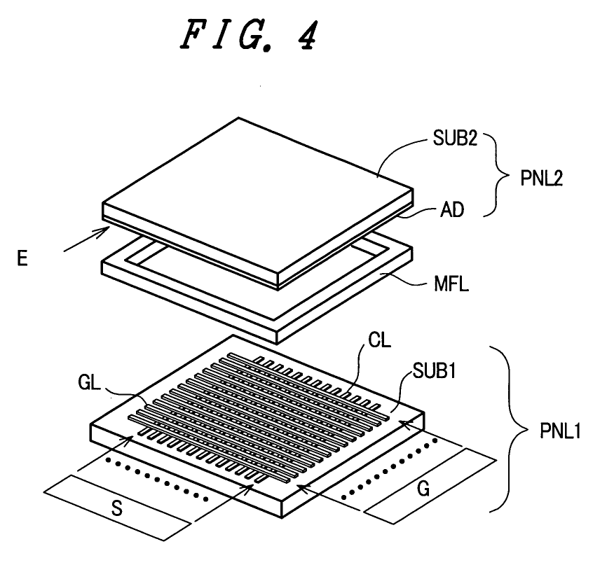

In FIG. 3, the emission characteristics of the carbon nanotube electron source layers shown in FIG. 2 are compared with those of prior carbon nanotube electron sources. Electric field (V/μm) is plotted on the horizontal axis, while current density (mA/cm²) is plotted on the vertical axis. In FIG. 3, characteristic curve a indicated by the solid line indicates the characteristics obtained by the present invention. Characteristic curve b indicated by the broken line indicates the prior characteristics. As shown in FIG. 3, the layer of carbon nanotube electron sources of the present invention can produce large currents at a low electric field. Furthermore, it can be seen that the emission site density is improved from 1000/cm² to 100 million/cm², thus greatly improving the uniformity within the display plane.

### Embodiment 1

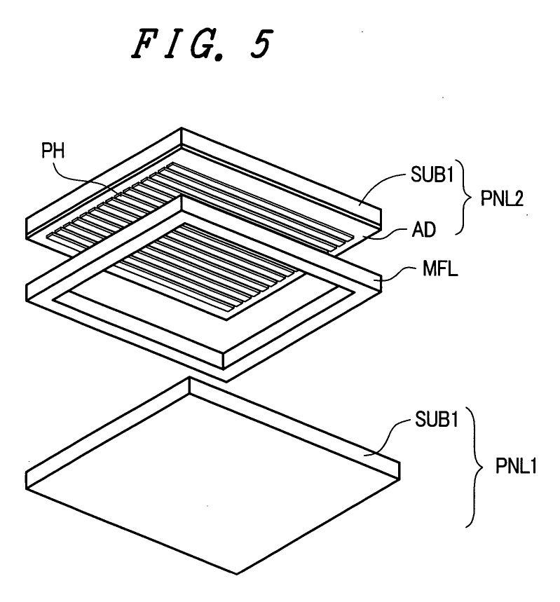

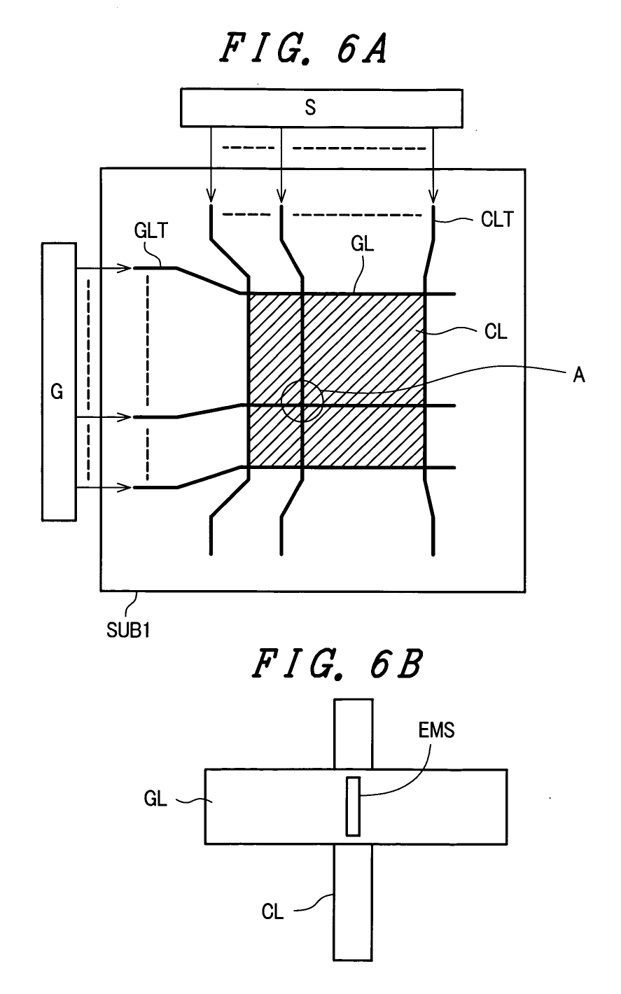

A self-luminous flat panel display according to embodiment 1 of the present invention will be described with reference to FIGS. 4-7B. FIG. 4 is an expanded perspective view of the self-luminous flat panel display of embodiment 1, as viewed obliquely from above. FIG. 5 is an expanded perspective view of the self-luminous flat panel display of embodiment 1, as viewed obliquely from below. The self-luminous flat panel display of embodiment 1 is fabricated by bonding together a rear substrate SUB1 and a front substrate SUB2 via sealing frames MFL. The substrates SUB1 and SUB2 form a rear panel PNL1 and a front panel PNL2, respectively.

In FIGS. 4 and 5, a multiplicity of cathode electrodes CL, extending in one direction, and juxtaposed in another direction intersecting the one direction and a multiplicity of gate electrodes GL, extending in the other direction and juxtaposed in the one direction, are formed on the inner surface of the rear substrate SUB1. Electron sources consisting of the aforementioned carbon nanotubes are formed at the intersections of the gate electrodes GL on the cathode electrodes CL. A cathode signal (video signal) is supplied to the cathode electrodes CL from a cathode signal source (video signal source) S. A gate signal (scanning signal) is applied to the gate electrodes GL from a gate signal source (scanning signal source) G. Electrons are emitted from the electron sources of the cathode electrodes CL intersecting the gate electrodes GL selected by the gate signal.

Multiple colors of fluorescent layers PH are formed on a display area on the inner surface of the front substrate SUB2 and aligned to the positions of the electron sources formed in the rear substrate SUB1. In FIG. 5, the fluorescent layers PH may be arranged as stripes or dots. An accelerating electrode (anode) AD is formed as a layer under the fluorescent layers PH on the front substrate SUB2. The anode AD may also be formed as a layer on top of the fluorescent layers PH. A given anode voltage is applied to the anode AD from a high voltage source E. Each electron emitted from the electron sources of the cathode electrodes CL is accelerated by the high voltage applied to the anodes AD and collides against a given one of the fluorescent layers PH, emitting a given color of light. A two-dimensional image is displayed by controlling emission of colors of light from the fluorescent layers over the whole display area of the front substrate SUB2.

Where the screen size is large, partition walls (spacers) made of thin glass plates are mounted inside the sealing frames MFL at given intervals to maintain the space between each electron source of the rear substrate SUB1 and each fluorescent layer of the front substrate SUB2 at a given value.

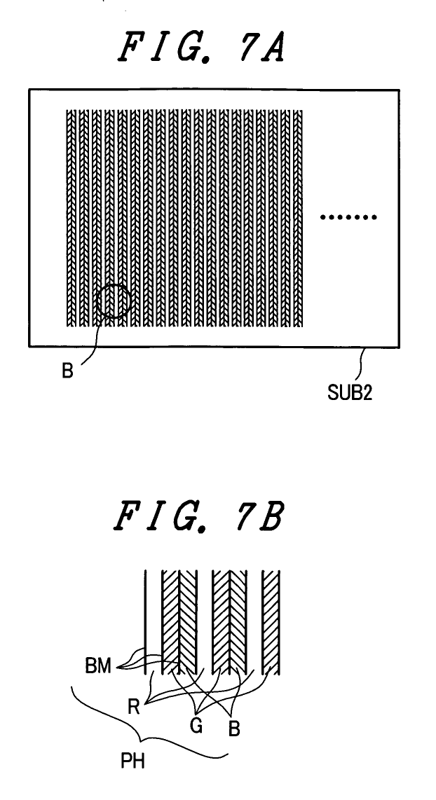

FIG. 6A is a plan view diagrammatically illustrating an example of the configuration of the rear panel in embodiment 1, showing the whole configuration. FIG. 6B is an enlarged view of main portions in the area A of the configuration shown in FIG. 6A. In FIG. 6A, plural cathode electrodes CL are formed on the inner surface of the rear substrate SUB1 constituting the rear panel, the electrodes CL extending in the vertical direction, as viewed in the figure. A multiplicity of gate electrodes GL are formed in the horizontal direction. The cathode electrodes CL and gate electrodes GL intersect each other via an insulator layer. Electron sources EMS formed by the aforementioned carbon nanotubes of the present invention are formed at the intersections.

The electron sources EMS, consisting of the carbon nanotubes, are formed on the surfaces of the cathode electrodes CL at the bottoms of holes extending through the gate electrodes GL and through the underlying insulator layer (not shown). In the case of a color display, one electron source emits electrons to excite one subpixel to emit light. One pixel is composed of at least three subpixels. For example, a subpixel for red, a subpixel for green, and a subpixel for blue constitute one pixel. One end of each cathode electrode CL forms an extraction line CLT from the cathode electrode. A cathode signal (video signal) is supplied to the cathode electrode CL from the cathode signal source S. Furthermore, one end of each gate electrode GL forms an extraction line GLT from the gate electrode. A scanning signal is supplied to the extraction line GLT from the scanning signal source G.

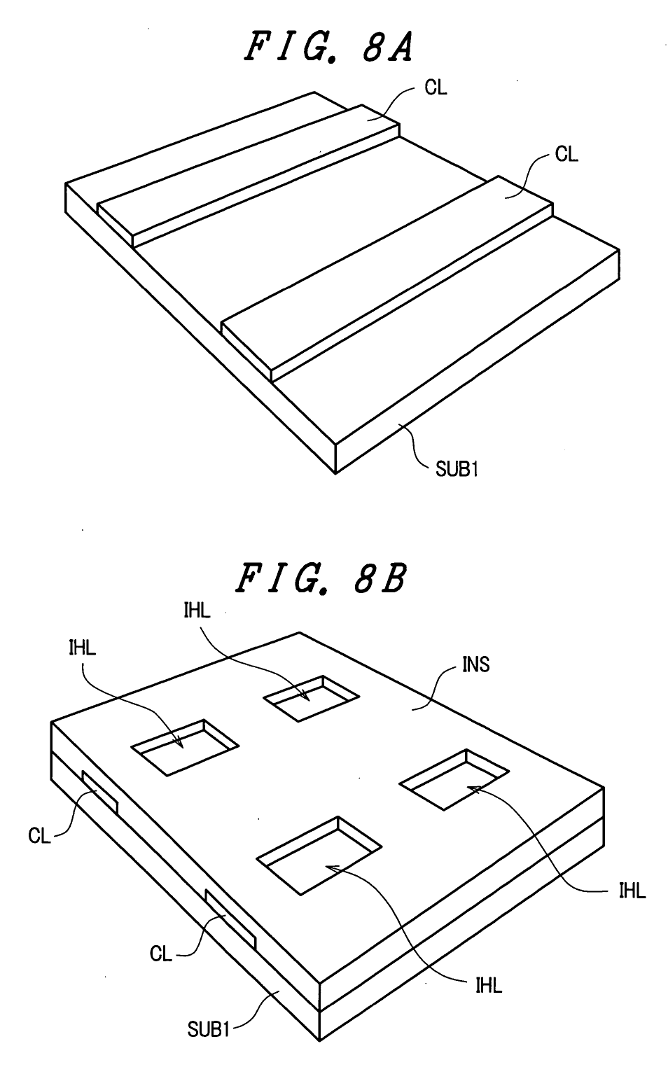

FIG. 7A is a plan view diagrammatically illustrating an example of configuration of the front panel constituting the self-luminous flat panel display of embodiment 1. FIG. 7B is an enlarged view of main portions B of the configuration shown in FIG. 7A. The front panel has anodes on the inner surface of the front substrate SUB2, the anodes having a film thickness of tens of nanometers to hundreds of nanometers. Stripes of fluorescent layers for red (R), green (G), and blue (B) are partitioned from each other by light-shielding layers (black matrix) BM to form a fluorescent surface.

The fluorescent surface is formed as follows. First, a slurry is prepared by mixing a light-absorbing material and a photosensitive resin. Stripes of black matrix BM are formed in the midpoints between the electron sources EMS having the same pitch in the lateral (horizontal) direction of the electron sources EMS, as seen in FIG. 6, by application of the slurry, mask exposure, and a well-known lift-off technique using aqueous hydrogen peroxide. Then, using a slurry method, repeating patterns of the stripes of fluorescent materials for red (R), green (G), and blue (B) are formed. Thus, the fluorescent layer PH is formed in which black matrix regions BM are located at both ends of each fluorescent material.

The front panel is fabricated in this way to overlap the rear panel via the sealing frames MFL and partition walls. The electron sources and fluorescent materials are placed in position. The inner space is evacuated to a vacuum and sealed, thus fabricating a display panel. A driver circuit and other components are added. In this way, a self-luminous flat panel display is completed. The front panel, sealing frames MFL, and the rear panel are sealingly bonded together using frit glass. This bonding operation is carried out by printing frit glass on the sealed surface or applying frit glass on the sealed surface using a dispenser, heating the glass to about 450° C., and melting and bonding the glass to the sealed surface. With respect to the panel assembly fabricated by sealingly bonding together the front panel, sealing frames, and rear panel, an exhaust pipe is mounted to any one of the front panel, sealing frames, and rear panel. Usually, the pipe is mounted to an appropriate location positioned outside the display region of the rear panel and within the sealing frames. The inner space is evacuated from the exhaust pipe. The pipe is sealed off when a given degree of vacuum is reached.

The cathode signal source, gate signal source, high voltage source, and other additional circuits and components are mounted to the display panel fabricated as described above, thus building a self-luminous flat panel display. Desired images of high quality could be obtained by driving this self-luminous flat panel display.

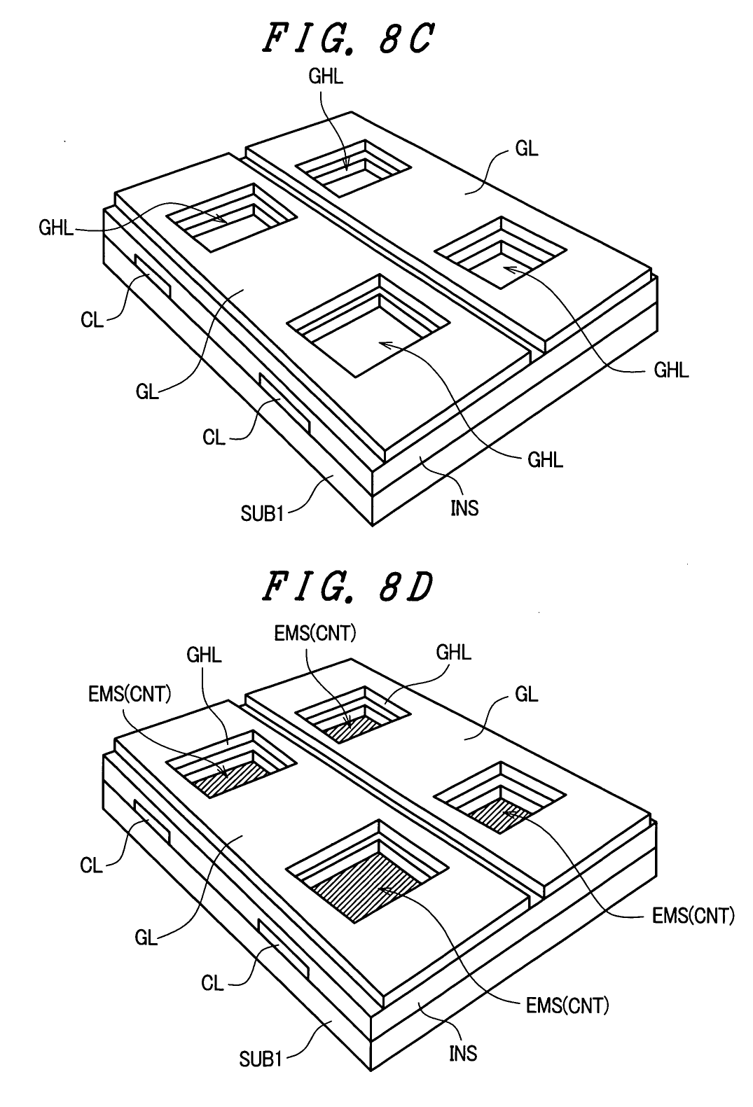

An example of the structure of the rear panel of the self-luminous flat panel display of the present invention described hereinafter with reference to FIGS. 8A-8D. FIGS. 8A-8D illustrate steps in a process for fabricating an example of structure of the rear panel of the self-luminous flat panel display of the invention. Of all the subpixels formed on the display region, four (2×2) subpixels are considered. As shown in FIG. 8A, a paste containing a conductive material, such as silver paste, is printed on the surface of the rear substrate SUB1 by screen printing. The paste is sintered to form stripes of cathode electrodes CL. The stripes of cathode electrodes CL are made of silver. The width is 100 μm, for example, and the spacing is 100 μm. The thickness of the sintered film is 5 μm. The number of the formed stripe-like cathode electrodes CTL is 1280×3=3840.

Then, as shown in FIG. 8B, an insulator layer INS is applied by screen printing and is sintered. The insulator layer INS is provided with insulator layer holes IHL at the positions of the electron sources in the cathode electrodes CL. The thickness of the sintered insulator layer INS is about 10 μm, for example.

Subsequently, as shown in FIG. 8C, after the formation of the insulator film INS, silver paste is screen-printed and sintered to form the stripes of gate electrodes GL. The gate electrodes GL are provided with the gate electrode holes GHL at the same positions as the insulator layer holes IHL. The gate electrode holes GHL are made larger than the insulator layer holes IHL to prevent the silver paste for the gate electrodes from running down into the underlying insulator layer holes IHL during the process of forming the gate electrodes GL. The width of each gate electrode GL is 700 μm. The spacing is 100 μm. The thickness of the sintered film is 5 μm. In the present embodiment, the number of such gate electrodes GTL is 720.

Then, as shown in FIG. 8D, ink containing the electron source layers EMS (CNT) of carbon nanotubes is applied into the gate electrode holes GHL by an ink jet process. The ink used in the ink jet technology contains gold particulates and organic solvent as a support body, as well as the carbon nanotubes. Furthermore, to improve the electrical contact between the carbon nanotubes and the cathode electrodes, metal particulates may be added. Finally, the surface is processed to bristle the carbon nanotubes. Laser irradiation, plasma processing, mechanical treatment, or other technique can be used as the surface treatment.

As described thus far, an electron source structure of carbon nanotubes, which can be gated on and off, can be fabricated using screen printing and ink jet printing. In the fabrication process described above, each printed film is sintered after the end of each application process. Furthermore, after formation of all the layers of the carbon nanotubes, the layers may be sintered only once to form a thin film containing the carbon nanotubes. Then, the thin film may be sintered once more at a relatively low temperature. After the sintering, carbon nanotube electron sources are fabricated by applying a layer of a tacky organic substance, the layer is dried, and then the layer is peeled off.

In the present embodiment, the cathode and gate electrodes are fabricated by applying silver paste. Whatever metal having the required electrical conductivity can be used. In addition, alloy and multilayered metal film may also be used. Moreover, the method of applying the carbon nanotube electron sources is not limited to ink jet printing. Other special printing techniques or vapor phase deposition may also be employed.

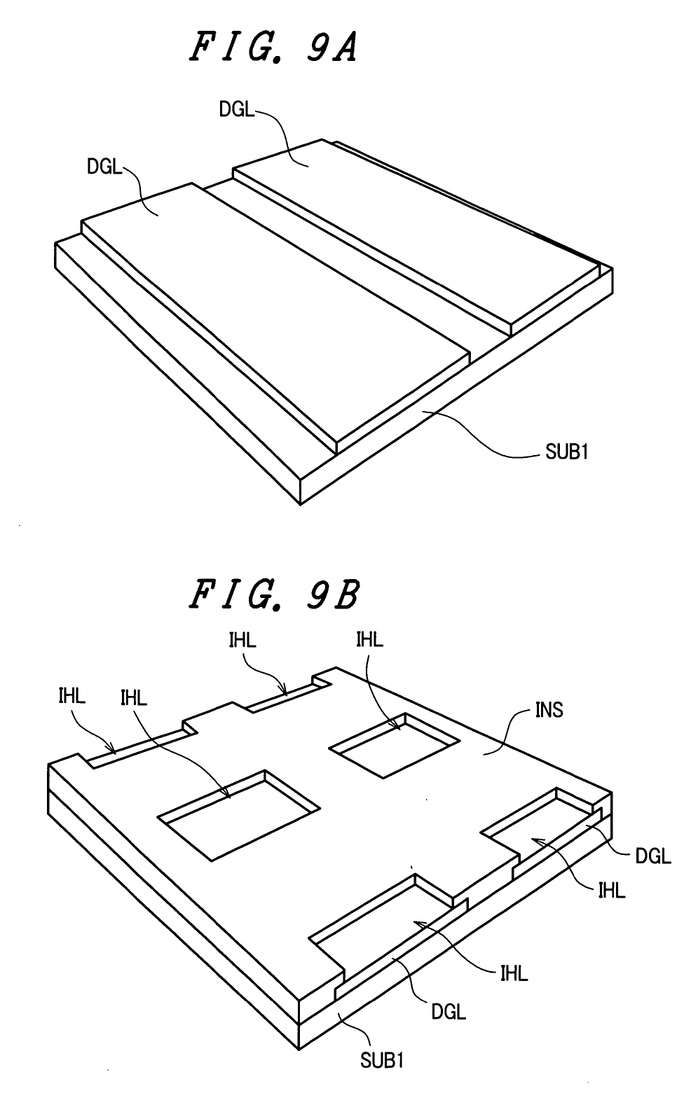

FIGS. 9A-9D show another example of the structure of the rear panel in the self-luminous flat panel display of the present invention. FIGS. 9A-9D illustrate steps in a process for fabricating this other example of the rear panel in the self-luminous flat panel display of the invention. Of all of the subpixels formed on the display region, four (2 □ 2) subpixels are described. This example of the structure is different and its fabrication process is different from the structure and the process of the rear panel already described in connection with FIGS. 8A-8D. First, as shown in FIG. 9A, silver paste is printed on the rear substrate SUB1 by screen printing, the rear substrate being preferably made of glass. The paste is sintered to form sintered lower gate electrodes DGL. The width of each lower gate electrode DGL is 700 μm. The spacing is 100 μm. The thickness of the sintered film is 5 μm. The number of formed such lower gate electrodes DGL is 720.

Then, as shown in FIG. 9B, an insulator layer INS is applied by screen printing and is then sintered. The insulator layer INS is formed in such a way that insulator layer holes IHL are located over the lower gate electrodes DGL. The thickness of the sintered insulator film INS is 10 μm.

Then, as shown in FIG. 9C, upper gate electrodes AGL and cathode electrodes CL are formed at the same time by applying and sintering screen-printed silver paste. The upper gate electrodes AGL contain the portions of the insulator layer holes IHL and are larger than the portions of the holes IHL. The upper gate electrodes AGL and lower gate electrodes DGL are electrically connected together. The thickness of the sintered upper gate electrodes AGL is 5 μm. The width of each cathode electrode CL is 100 μm. The spacing is 100 μm. The thickness of the sintered film is 5 μm. The number of the formed cathode electrodes CL is 1280×3=3840.

As shown in FIG. 9D, electron source layers EMS (CNT), consisting of carbon nanotubes, are applied on the cathode electrodes CL by screen printing. Each electron source layer EMS (CNT) is narrower than each cathode electrode CTL, but shorter than the adjacent upper gate electrodes AGTL. At least a support body consisting of gold particulates is contained in the electron source layers EMS (CNT), together with carbon nanotubes. Particulates of other metal may be contained therein to improve the electrical contact between the cathode electrodes and the carbon nanotubes.

After application of the electron source layers EMS (CNT) consisting of nanotubes, the layers are heat-treated at a temperature higher than the melting temperature of the cathode electrodes, thereby fabricating electron sources in which some end portions of the carbon nanotubes are fixedly buried near the surfaces of the cathode electrodes together with parts of the support body. Then, a surface treatment is performed to bristle the carbon nanotubes. Laser irradiation, plasma processing, mechanical treatment, or other technique can be used as the surface treatment.

As described so far, an electron source structure of carbon nanotubes that is capable of being gated on and off can be fabricated using a screen printing technique. In the fabrication process described above, each printed film is sintered after the end of each application process. Furthermore, after formation of all the layers of the carbon nanotubes, the layers may be sintered only once to form a thin film containing the carbon nanotubes. Then, the thin film may be sintered once more at a relatively low temperature. After the sintering, carbon nanotube electron sources are fabricated by applying a layer of a tacky organic substance, drying the layer, and then peeling off the layer.

In the present embodiment, the cathode and gate electrodes are fabricated by applying silver paste. Whatever metal, having the required electrical conductivity, can be used. In addition, alloy and multilayered metal film may also be used. Moreover, the method of applying the carbon nanotube electron sources is not limited to ink jet printing. Other appropriate printing methods may also be employed.

Note that the nanotubes are not limited to the aforementioned carbon nanotubes. Well-known nanotubes may also be used.

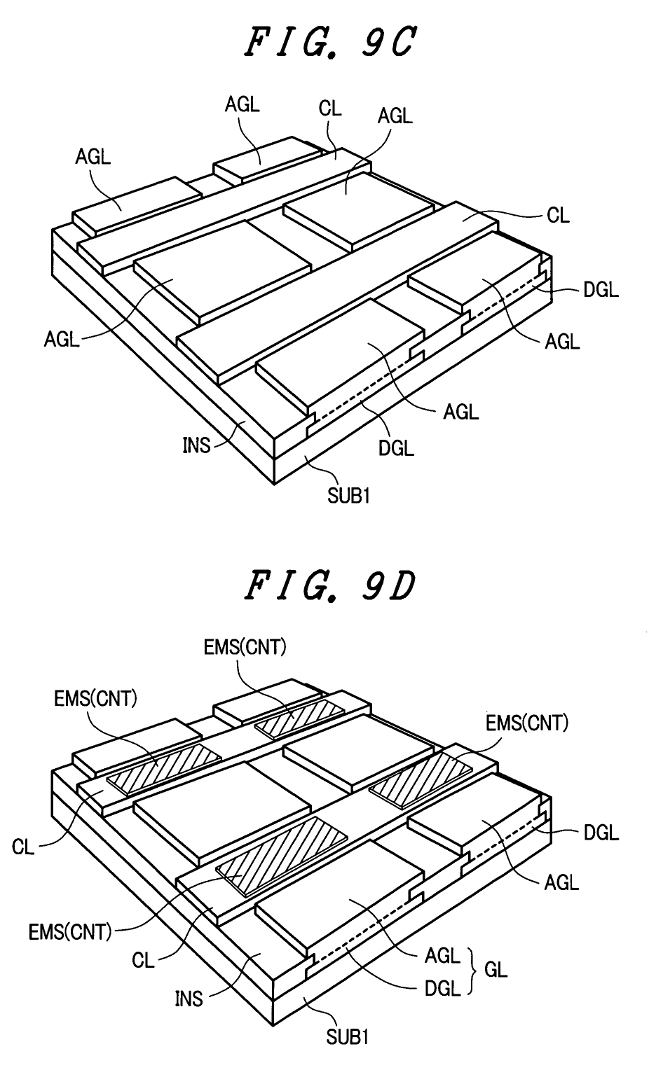

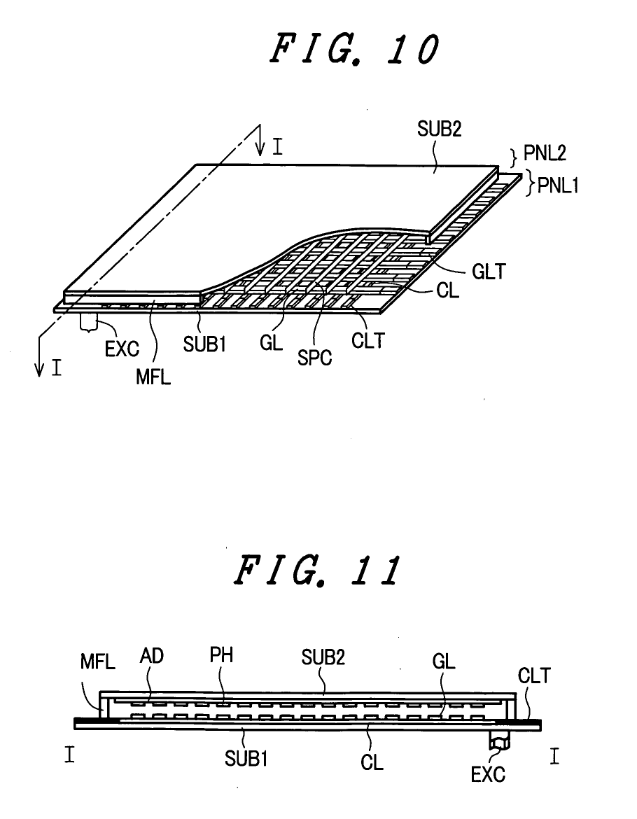

FIG. 10 is a partially cutaway perspective view of one example of the whole structure of the self-luminous flat panel display according to the present invention. FIG. 11 is a cross-sectional view taken along line I-I of FIG. 10. Cathode electrodes CL and gate electrodes GL are formed on the inner surface of a rear substrate SUB1 constituting a rear panel PNL1. Electron sources are formed at the intersections of the cathode electrodes CL and gate electrodes GL. Cathode electrode extraction lines CLT are formed at ends of the cathode electrodes CL. Gate electrode extraction lines GLT are formed at ends of the gate electrodes GL.

Anodes and fluorescent layers, as described above, are formed on the inner surface of a front substrate SUB2 constituting a front panel PNL2. The rear substrate SUB1 constituting the rear panel PNL1 and the front substrate SUB2 constituting the front panel PNL2 are bonded together after interposing sealing frames MFL at the fringes of the substrates. To hold the spacing between the bonded substrates at a desired value, partition walls SPC, preferably made of glass plates, extend between the rear substrate SUB1 and the front panel PNL2. Since FIG. 11 is a cross-sectional view taken along the partition walls SPC, the partition walls SPC are omitted.

The inner space sealed by the rear substrate SUB1, front panel PNL2, and sealing frames MFL is evacuated from an exhaust pipe EXC mounted to a part of the rear panel PNL1 to achieve a desired vacuum state.

What is claimed is:

1. A flat panel display comprising:
a rear panel having plural cathode electrodes extending in a first direction and juxtaposed in a second direction perpendicular to the first direction, plural gate electrodes extending in the second direction and juxtaposed in the first direction, and electron sources disposed at intersections of the cathode electrodes and the gate electrodes; and
a front panel having plural colors of fluorescent layers and anode electrodes, the colors of fluorescent layers being excited to emit light by electrons extracted from the electron sources;
wherein the electron sources have nanotubes; and
wherein the nanotubes are composed of two or more layers of multi-walled carbon nanotubes and single-walled carbon nanotubes.

2. A flat panel display comprising:
a rear panel having plural cathode electrodes extending in a first direction and juxtaposed in a second direction perpendicular to the first direction, plural gate electrodes extending in the second direction and juxtaposed in the first direction, and electron sources disposed at intersections of the cathode electrodes and the gate electrodes; and
a front panel having plural colors of fluorescent layers and anode electrodes, the colors of fluorescent layers being excited to emit light by electrons extracted from the electron sources;
wherein the electron sources have nanotubes; and
wherein the nanotubes are composed of three or more layers of multi-walled carbon nanotubes and double-walled carbon nanotubes.

3. A flat panel display as set forth in claim 1, wherein distribution of diameters of the single-walled carbon nanotubes has a half-value width that is within ±10% of their average diameter.

4. A flat panel display as set forth in claim 2, wherein distribution of diameters of the single-walled carbon nanotubes has a half-value width that is within ±10% of their average diameter.

5. A flat panel display as set forth in claim 1, wherein rate of the single-walled carbon nanotubes to all contained carbon nanotubes is more than 1%.

6. A flat panel display as set forth in claim 2, wherein rate of the double-walled carbon nanotubes to all contained carbon nanotubes is more than 1%.

7. A flat panel display as set forth in claim 1, wherein the nanotubes contain atoms of nitrogen or boron other than carbon.

8. A flat panel display as set forth in claim 2, wherein the nanotubes contain atoms of nitrogen or boron other than carbon.

9. A flat panel display as set forth in claim 1, wherein the nanotubes contain no carbon but contain atoms of any one or both of nitrogen and boron.

10. A flat panel display as set forth in claim 1, wherein the electron sources have been formed by screen printing, vapor phase deposition, or ink jet printing.

11. A flat panel display as set forth in claim 2, wherein the electron sources have been formed by screen printing, vapor phase deposition, or ink jet printing.

12. A flat panel display as set forth in claim 1, wherein there are provided plural partition walls between the rear panel and the front panel.
